(19) United States
(12) Patent Application Publication
(10) Pub. No.: US 2008/0163317 A1
(43) Pub. Date: Jul. 3, 2008

(54) Generation of video streams from content items

(75) Inventor: Michael Mills, Redwood City, CA (US)

Correspondence Address: YAHOO! INC.;C/O DREIER LLP, 499 PARK AVENUE, NEW YORK, NY, 10022, US

(73) Assignee: Yahoo! Inc., Sunnyvale, CA (US)

(21) Appl. No.: 11/648,288

(22) Filed: Dec. 29, 2006

(51) Int. Cl. H04N 7/173

(52) U.S. Cl. 725/109

(57) ABSTRACT

The present invention is directed towards systems and methods for the generation of a video stream from a source content item, such as a web page. One embodiment of the method comprises receiving a content item for conversion to a video stream, loading a extraction template, the extraction template comprising one or more transformation functions for the conversion of the content item to a video stream, and applying the transformation functions from the extraction template to the content item for conversion to a video stream. The video stream may be stored on an output data store.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention relates to the generation of one or more video streams. More particularly, the invention is directed to systems and methods for the generation of a video stream from one or more content items, e.g., one or more still images, or content comprising a content item, e.g., a web page.

### BACKGROUND OF THE INVENTION

With the advent of digital “showcases” for user contributed content, a wide variety of such content has become available on-line. For example, authors publish weblogs or “blogs” that are essentially digital, networked diaries comprising text, audio, video, etc., on a wide variety of topics. In addition to blogs, other types of forums for the display of user generated or contributed content have been proliferating. For example, the Flickr® web site and web service allow users to post digital photographs or images, as well as related information such as title, annotations, photograph information, etc., to Flickr for sharing with other users.

Although there are many modes through which a user may make content available on a network, such as the Internet, any given mode is limited as to the manner in which the content is made available. For example, using the Flickr web site, users are limited to posting still images and annotations. Thus, there is a need for systems and methods that allow content to made available in a more flexible manner than heretofore provided in the art. According to one embodiment, systems and methods are needed that allow users to generate one or more video streams from one or more content items, such as images and annotations on a web page.

### SUMMARY OF THE INVENTION

Embodiments of the present invention are directed towards systems and methods for the generation of a video stream from one or more content items, e.g., images, text, combinations thereof such as web pages, etc. According to one embodiment, a method for the generation of a video stream from a content item comprises receiving a content item for conversion to a video stream and loading a extraction template, the extraction template comprising one or more transformation functions for the conversion of the content item to a video stream. The transformation functions from the extraction template are applied to the content item for conversion to a video stream, which may be stored on a data store, e.g., file system, relational database, etc.

Receipt of a content item may comprise receipt of a plurality of disparate types of content items. For example, a content item may comprise a web page. According to one embodiment, the web page is a “static” web page whereby the content is stored in a file (e.g., HTML file) and a user updates the content by modifying the markup code of the web page. Alternatively, or in conjunction with the foregoing, the web page is a “dynamic” web page that may be programmatically generated in response to a request for the page (e.g., a Active Server Page, Java Server Page, etc.) and a user updates the content by modifying program code and markup code of the web page. Execution of the step of receiving the content item may be made in response to detecting a change in the content item, the expiration of a time window, or other event.

A user profile for a given user may store information for the conversion of the content item into a video stream. According to one embodiment, the user profile for the given user may identify the content item and the extraction template for use in the conversion. The profile or the extraction template may indicate an output format for the video stream. For example the output may comprise a QuickTime® video stream, a Flash® video stream, a Windows Media Video® video stream, a Real® video stream, etc.

The resultant video stream may be written to a data store for persistent or transient storage of the video stream. According to one embodiment, the use profile for the given user is operative to maintain one or more storage templates. A storage template may govern the manner is which a given video stream is written to the data store and may comprise one or more storage rules for the storage of the video stream. For example, the video stream may be made available for access by client device through the publication of a Uniform Resource Locator (“URL”) at which the a client may access the video stream. Alternatively, the method may comprise embedding or otherwise including the video stream within a content item, such as a web page, from which visitors may access the video stream. Where no storage template is available, the method may load and utilize one or more default storage rules.

Another embodiment of the invention is directed towards computer readable media for the storage of program code that instructs a programmable processor to execute a method for the generation of a video stream from a source content item. Exemplary program code in accordance with the present embodiment comprises program code for receiving a content item for conversion to a video stream and program code for loading a extraction template, the extraction template comprising one or more transformation functions for the conversion of the content item to a video stream. The computer readable media further comprises program code for applying the transformation functions from the extraction template to the content item for conversion to a video stream and program code for storing the video stream on a data store.

The program code for receiving the content item may comprise program code for receiving a web page. As indicated able, a given page may be a static web page or a dynamic web page. The program code for receiving the content item may be executed in response to the detection of a change in the content item. Similarly, the program code for receiving the content item may be executed in response to the expiration of a time window. The program code may also comprise program code for identifying the content item and the extraction template in a user profile, and the program code for applying may comprise program code for generating a QuickTime video stream, a Flash video stream, etc.

According to one embodiment, the program code for storing the video stream comprises program code for loading a storage template, the storage temple comprising one or more storage rules for storage of the video stream, and may further comprise program code for storing the video stream at a unique Uniform Resource Locator. Alternatively, or in conjunction with the foregoing, the program code for storing comprises program code for storing the video stream as part of a content item, which may comprise program code for embedding the video stream in a web page. Default storage rules may also be utilized.

According to other embodiments, the present invention is directed towards a method for obtaining a template for conversion of a content item to a video stream. The method according to one embodiment comprises receiving a request at a marketplace for a template and retrieving one or more templates that are responsive to the request. A given template is selected from among the one or more responsive templates (which may be performed be a user or software process) and a purchase transaction is executed for the template. In addition to retrieving templates, one or more advertisements that are responsive to the request may also or alternatively be retrieved, which may be displayed to (and selected by) the user from which the request was received. Executing the purchase transaction may comprise downloading the selected template, and may further comprise verifying payment for the selected template prior to downloading. The templates, according to various embodiments, may be combinations of extraction templates and storage templates.

Embodiments of the invention are also directed towards systems for the generation of a video stream from a source content item. A system according to one embodiment comprises a template data store for storage of an extraction template comprising one or more transformation functions for the conversion of a content item to a video stream and an extraction component operative to receive the content item and apply a given transformation function from the extraction template to the content item for conversion to a video stream. The system may also comprise a video stream data store for storage of the video stream that the extraction component generates.

The extraction component is operative to receive the content item, which may be a web page (which may also be a static web page or a dynamically generated web page, e.g., JSP, ASP, etc.) The extraction component may receive the content item response to the detection of a change in the content item, such as an update to or modification of the content item. Alternatively, or in conjunction with the foregoing, the extraction component may receive the content item response to the detection of the expiration of a time window. In addition to storage of the extraction template, the template data store may be operative to maintain a storage template comprising one or more storage rules for storage of the video stream. Embodiments of the system may also comprise a profile data store for the storage of a user profile that identifies the content item, the extraction template or the storage template.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a system for generating a video stream on the basis of one or more input content items according to one embodiment of the present invention;

FIG. 2 is a flow diagram illustrating a process for generating a video stream on the basis of one or more input content items according to one embodiment of the present invention;

FIG. 3 is a flow diagram illustrating a process for generating a video stream on the basis of one or more input content items through the use of a transformation template and a storage template according to one embodiment of the present invention;

FIG. 4 is a flow diagram illustrating a process for publishing a video stream according to one embodiment of the present invention; and

FIG. 5 is a flow diagram illustrating a process for sharing extraction templates and storage templates in a template marketplace.

### DETAILED DESCRIPTION OF THE EMBODIMENTS

In the following description of the embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

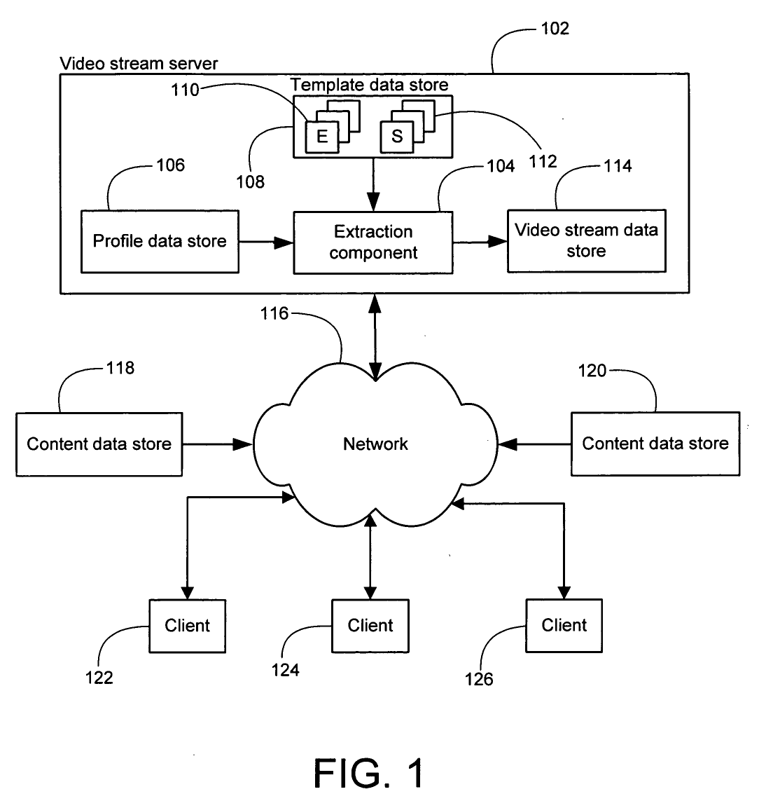

FIG. 1 presents a block diagram illustrating one embodiment of a system generating video streams from one or more content items. The system of FIG. 1 comprises a video stream server102, one or more content data stores 118 and 120 and one or more client devices 122, 124 and 126. The video stream server 102, content data stores 118 and 120, and clients 122, 124 and 126 may be in communication over a network 116. The network 116 may comprise one or more interconnected local or wide area networks and may comprise various combinations of wired and wireless transmission mediums, e.g., the Internet.

One or more client devices 122, 124 and 126 may be in communication with the network 116 through the use of a network interface (not pictured). A given client 122, 124 and 126 may be communicatively coupled to the network 116 to transmit data over the network 116 and process information that the given client 122, 124 and 126 receives over the network 116. According to one embodiment, a given client device 122, 124 and 126 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A user at a given client device 122, 124 and 126 may communicate over the network 116 with the video stream server 102 to generate a video feed on the basis of one or more content items at one or more content data stores 118 and 120. According to one embodiment, the video stream server 102 comprises an extraction component 104, a profile data store 106, a template data store 108 and a video stream data store 114. The extraction component 104, which may comprise one or more items of program code for execution by a programmable processor, receives information from a client device 122, 124 and 126 that identifies a given user of the video stream server 102, and retrieves a user profile for the user from the profile data store 106.

The user profile that the extraction component 104 retrieves from the profile data store 106 may identify information regarding a given user an actions that the user has taken in the past with regard to the generation of video streams. The profile for a given user may also identify rules that the extraction component 104 may utilize to generate a video stream, as well as store a video stream. According to one embodiment, a template data store 108 is operative to maintain one or more extraction templates 110, as well as one or more storage templates 112. Accordingly, a user profile from the profile data store 106 may identify one or more extraction templates 110, as well as one or more storage templates 112, for the extraction component 104 to utilize in the generation of a video stream.

A given extraction template 110 comprises one or more extraction functions or instructions, which according to one embodiment are rules, which the extraction component 102 may utilize to extract information from one or more content items at a given content data store 118 and 120. A given extraction template 110 may also instruct the extraction component 104 as to the manner in which a video stream is to be constructed from the extracted information. For example, assume a content item at the content data store 118 and 120 is a web page comprising images and accompanying text. The extraction template 1 10 may comprise one or more functions, instructions or rules that instruction the extraction component 104 as to the manner in which these data are to be complied into a video stream. According to one embodiment the extraction template 110 may instruct the extraction component 104 to insert a first image into the video stream, display associated text for five seconds, perform a wipe transition, insert a second image into the video stream, transition associated text over the second image, perform a wipe transition, etc. The extraction component 104 builds the video stream and encodes the video stream using a compressor/decompressor (not pictured) including, but not limited to, Divx, Xvid, QuickTime, WMA, Real, Flash, etc.

A given storage template 112 comprises one or more storage functions or instructions, which according to one embodiment are rules, which the extraction component 102 may utilize to save a resultant video stream to one or more video stream data stores 114. According to one embodiment, the storage template instructs the extraction component to make the video stream available at a given Uniform Resource Locator. Alternatively, or in conjunction with the foregoing, the storage template 112 may comprise instructions regarding the generation or modification of a content item to include the video stream. For example, the extraction component 104 may modify a web page to include a link to the video stream on the basis of the storage template 112. Where there is no storage template 112 available, the extraction component 104 may operate in accordance with one or more default storage rules to store the video stream on a video stream data store 114 and make the video stream available to requesting viewers.

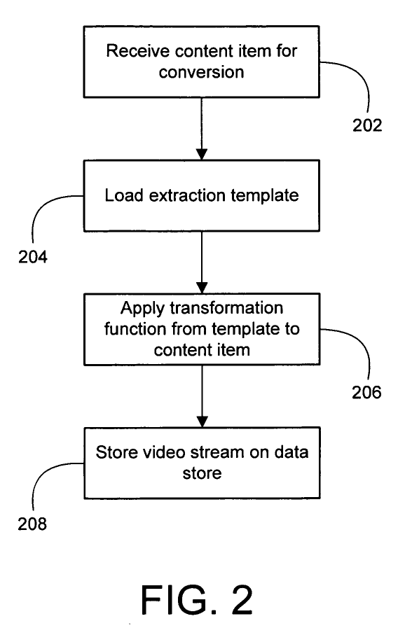

FIG. 2 illustrates a method in accordance with one embodiment of the present invention for generating a video stream from one or more content items. According to the exemplary method of FIG. 2, the process begins with the receipt of one or more content items for conversion into a video stream, step 202. According to one embodiment, content items include video, images, text, audio and other content. Content items may also include web pages with audio, video, images, text, etc. embedded therein, e.g., receipt of a web page with images, text and links to other hypermedia sources, such as other web pages. A video stream server may receive the one or more content items for conversion into a video stream.

A extraction template, which a video stream server may retrieve from a template data store, is loaded for processing of the retrieved content item, step 204. According to one embodiment, the extraction template comprises one or more instructions or transformation functions that may govern the conversion of a content item into a video stream. For example, a extraction template may instruct the video stream server to identify one or more images in a content item for inclusion in a video stream such that the video stream displays the images sequentially as a slide show. The extraction template may further instruct the video stream server to identify text accompanying a given image from the content item for inclusion in the video stream, which the video stream server may include in the video stream in accordance with instructions within the extraction template. The extraction template may also define transitions between the presentation of content items in the video stream, such as fades, wipes, etc., which may comprise disparate transitions between the display of content items. The transformation functions are applied to the content item to generate a resultant video stream, step 206, which may comprise an extraction component at a video stream server applying the transformation functions in a given extraction template to one or more content items to generate a resultant video stream.

Application of the transformation function to one or more content items results in the generation of a video stream, which may be stored on a data store, step 208, which may be a video stream data store. Alternatively, or in conjunction with the foregoing, the video stream may be stored on a data store accessible over the network, such as a content data store, on a client device or other storage media. Additionally, the video stream may be stored in conjunction with one or more web page. For example, the video stream may be stored on a data store and embedded in a web page such that when a user views the web page the video stream is presented to the user on a given client device, or the video stream is presented in response to selection of a link to the video stream in the web page. The video stream may also be available on a data store for direct access by a user of a client device.

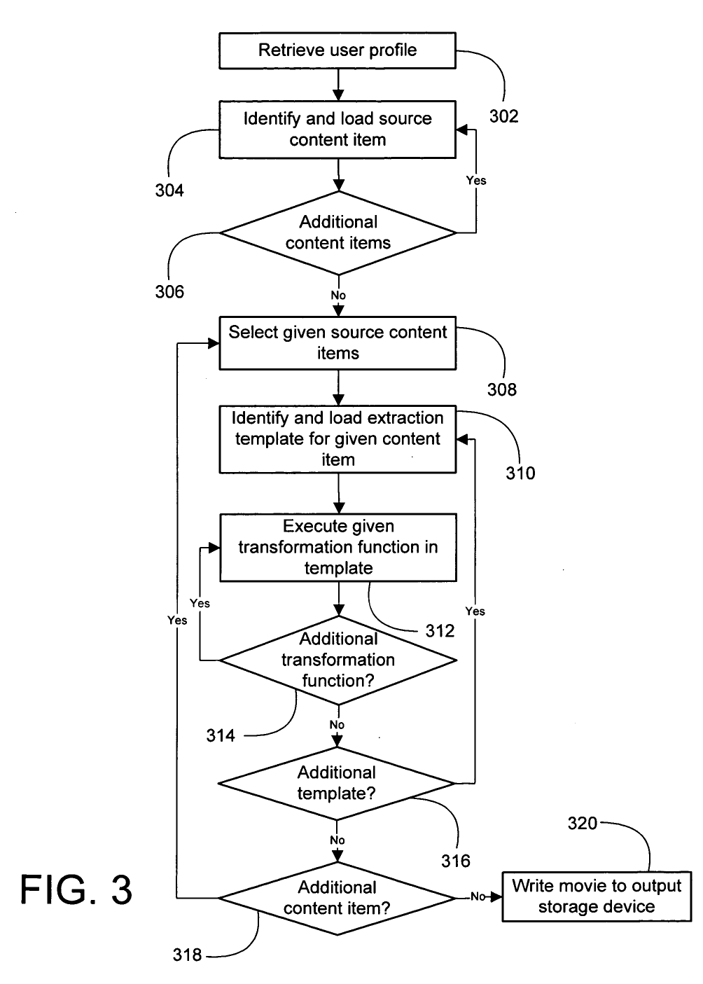

FIG. 3 illustrates an alternative method for the generation of a video stream in accordance with one embodiment of the invention. The method of FIG. 3 begins with the retrieval of a user profile, step 302. The user profile may be a profile for a user who is initiating the process of generating the video stream. The user profile may also list or otherwise identify one or more source content items or retrieve and load, step 304. An extraction component may retrieve a first source content item and perform a check to determine if additional source content items are available for retrieval, step 306. Where additional source content items are available, a subsequent source content item may be identified for loading into the system, step 304.

Where there are no additional source content items that exist for identification and loading, step 306, a given source content item is selected for processing, step 308. The video stream conversion process may begin with the identification and loading of a extraction template, step 310. The identification of a given extraction template may be on a per content item basis, e.g., a given content item has one or more extraction templates associated therewith for conversion of the content item to a video stream. Alternatively, there may be an association between multiple content and a given extraction template or vice versa. The one or more extraction templates are parsed to identify a given transformation function in the extraction template, step 312, which may instruct an extraction component as to the extraction of content from a given content item, as well as placement of the content in the video stream, the manner in which any transformations or effects are to be applied, etc. Where there is no extraction template identified, the video stream server may provide a default extraction template.

The given transformation function is executed, step 312, and a check determines if there are any additional transformation functions to apply to the given source content item, 314. For example, a given extraction template may identify multiple transformation function to manage the manner in which content is extracted from a given content item for placement into a video stream. Where there are additional transformation function in the transformation template, the subsequent transformation function is executed, step 312. Where there are no additional transformation functions in the given extraction template, step 314, a check determines if there are additional extraction templates for use in extracting content from the given content item for inclusion in the video stream, step 316. The check may analyze a user profile for the identification of a subsequent extraction template. Where the check step at 316 evaluates to true, processing returns to step 310 with the identification and loading of a subsequent extraction template.

Where the checks at steps 314 and 316 evaluate to false, e.g., there are no additional transformation functions in a given extraction template and no further extraction templates for processing the given content item, anther check may determine if there are additional content items for extraction an inclusion in the video stream, step 318. Where the check at step 318 evaluates to true, program flow returns to step 308 with the selection and processing of a subsequent given content item. Where there are no additional content items for inclusion in the video stream, step 318, a data store receives the resultant video stream for storage, step 320, which may comprise combinations of persistent and transient storage of the video stream. Receiving the video stream may also comprise encoding the video stream in accordance with a given compression/decompression (“codec”) technique including, but not limited to, QuickTime®, Flash®, RealMedia®, etc.

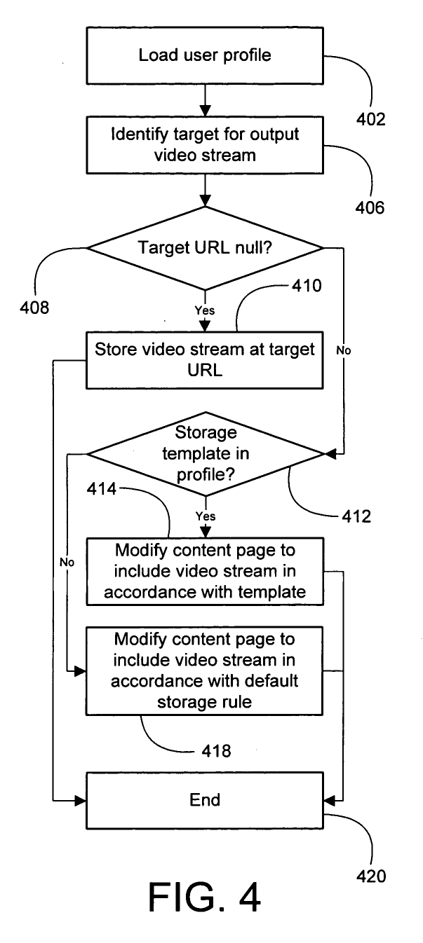

Systems and methods in accordance with embodiments of the present invention may store a given video stream. FIG. 4 illustrates one embodiment of a method for publishing or otherwise making a video stream available for users to view. According to one embodiment, a video stream is made available for viewing on the basis of information in a user profile for the user who is responsible for the generation of the video stream, step 402. In addition to information regarding the user and the manner in which to generate a video stream (e.g., extraction templates), the use profile may maintain information regarding the manner in which the video stream is to be made available, step 406, which may include the use of one or more storage templates

A check determines if the profile comprises a target URL to which the video stream is to be saved, step 408. As those of skill in the art are aware, a client device may directly access a given content item (such as a video stream) by providing a URL for the content item to a retrieval and rendering program. For example, a browser configured with a plug-in to view QuickTime movies may download and render a QuickTime video stream available at the URL “www.example.com/September1movice.mp4”. If the profile identifies a target URL to which to save the video stream, step 408, the extraction component may save the video stream at the target URL, which may comprise accessing one or more local or remote video stream data stores for storage of the video stream. The process may terminate after storage of the video stream at the target URL, step 420.

Where the profile does not comprise a target URL to which the video stream is to be saved, step 408, a check is performed to determine if the profile identifies one or more storage templates for use in storage of the video stream, step 412. According to one embodiment, a storage template may comprise one or more instructions, the execution of which causes a programmable processor to save the video stream, or make the video stream available to requesting viewers, in accordance with the instructions. A storage template may comprise instructions regarding the modification of a content item that acts as a container for the video stream. For example, the storage template may comprise instructions regarding the modification of a web page to include a link to the video stream, or modify the web page to include an embedded viewer for playback of the video stream.

Where the profile identifies one or more storage templates, step 412, the extraction component (or other software of hardware component at the video stream server) may modify a content item to include the video stream in accordance with the storage template, step 412. Where the target URL is null or otherwise not identified, step 408, and the profile does not identify a storage template, step 412, a content item (such as a web page) may be modified to include the video stream in accordance with one or more default storage rules, step 418, which may include a default target URL (which may further be a default target URL for the given user). Program flow then moves to termination block at step 420 and the process completes.

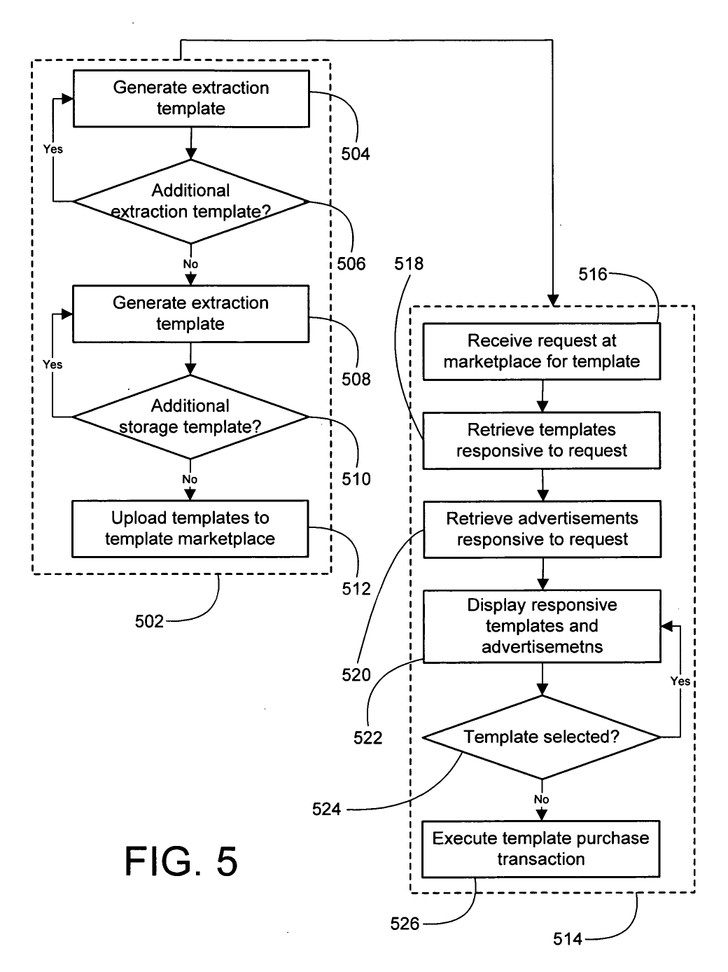

Extraction templates and storage templates that users create may be shared with other users in an on-line marketplace. FIG. 5 illustrates one embodiment of a method for sharing extraction templates and storage templates with an on-line template marketplace. According to one embodiment, the method comprises two sub-processes. A first sub-process 502 allows users to provide extraction templates and storage templates with the marketplace. According to the first sub-process 502, a user generates an fist extraction template, step 504, and a check is performed to determine if the user is attempting to generate one or more additional extraction templates, step 506. The user generates one or more extraction templates and may similarly generate a fist storage template, step 508, and a check is performed to determine if the user is attempting to generate one or more additional storage templates, step 510. When generation of the one or more extraction templates and one or more storage templates are complete, the templates are uploaded to a template marketplace for sharing, step 512. Alternatively, a user may upload a given template to the marketplace upon generation of the given template.

In accordance with a second sub-process 514, users may access the storage templates and extraction templates that other users provide. According to the second sub-process, the marketplace receives a request from a user for a template (extraction or storage), which may be in the form of a query comprising one or more keywords, step 516. On the basis of the query from the user, the marketplace may retrieve one or more extraction templates or storage templates that are responsive to the query, step 518. Additionally, the marketplace may by in communication with one or more advertisement serving systems through which the marketplace may retrieve one or more advertisements that are responsive to the user query, step 520.

The marketplace may present the user with extraction templates and storage templates that are responsive to the query, step 522. The display may include one or more advertisements that the marketplace may display to the user. A check is performed to determine if the user selects one of the extraction templates or storage templates that the marketplace is displaying, step 524. Where the user does not make a selection, the marketplace continues to display the extraction templates, the storage templates and any advertisements that are responsive to the user query, step 522. Where the user selects an extraction template or a storage template, the marketplace may execute a purchase transaction that allows the user issuing the query to purchase the template that he or she selects for use in generating or storing a video stream.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for the generation of a video stream from a source content item, the method comprising:
receiving a content item for conversion to a video stream;
loading an extraction template, the extraction template comprising one or more transformation functions for the conversion of the content item to a video stream;
applying the transformation functions from the extraction template to the content item for conversion to a video stream; and
storing the video stream on a data store.

2. (canceled)

3. The method of claim 1 comprising executing the receiving step in response to detecting a change in the content item.

4. The method of claim 1 comprising executing the receiving step in response to the expiration of a time window.

5. The method of claim 1 comprising identifying the content item and the extraction template in a user profile.

6. The method of claim 1 wherein storing comprises loading a storage template, the storage temple comprising one or more storage rules for storage of the video stream.

7. The method of claim 6 wherein storing comprises storing the video stream at a unique Uniform Resource Locator.

8. The method of claim 6 wherein storing comprises storing the video stream as part of a content item.

9. (canceled)

10. Computer readable media for the storage of program code that instructs a programmable processor to execute a method for the generation of a video stream from a source content item, the program code comprising:
program code for receiving a content item for conversion to a video stream;
program code for loading an extraction template, the extraction template comprising one or more transformation functions for the conversion of the content item to a video stream;
program code for applying the transformation functions from the extraction template to the content item for conversion to a video stream; and
program code for storing the video stream on a data store.

11. The program code of claim 10 wherein the program code for receiving comprises program code for receiving a web page.

12. The program code of claim 10 comprising program code for executing the program code for receiving in response to detecting a change in the content item.

13. The program code of claim 10 comprising program code for executing the program code for receiving in response to the expiration of a time window.

14. The program code of claim 10 comprising storing program code for identifying the content item and the extraction template in a user profile.

15. The program code of claim 10 wherein the program code for storing comprises program code for loading a storage template, the storage temple comprising one or more storage rules for storage of the video stream.

16. The program code of claim 15 wherein the program code for storing comprises program code for storing the video stream at a unique Uniform Resource Locator.

17. (canceled)

18. (canceled)

19. A method for obtaining a template for conversion of a content item to a video stream, the method comprising:
receiving a request at a marketplace for a template;
retrieving one or more templates that are responsive to the request;
selecting a template; and
executing a purchase transaction for the template.

20. The method of claim 19 comprising retrieving one or more advertisements that are responsive to the request.

21. The method of claim 20 comprising displaying the one or more templates and the one or more advertisements to a user from which the request was received.

22. The method of claim 19 wherein executing a purchase transaction comprises downloading the selected template.

23. The method of claim 22 comprising verifying payment for the selected template prior to downloading.

24. The method of claim 19 wherein retrieving comprises retrieving one or more templates selected from the set of templates including an extraction template and a storage template.

25. A system for the generation of a video stream from a source content item, the system comprising:
A template data store for storage of an extraction template comprising one or more transformation functions for the conversion of a content item to a video stream;
an extraction component operative to receive the content item and apply a given transformation function from the extraction template to the content item for conversion to a video stream; and
video stream data store for storage of the video stream that the extraction component generates.

26. (canceled)

27. The system of claim 25 wherein the extraction component receives the content item response to the detection of a change in the content item.

28. The system of claim 25 wherein the extraction component receives the content item response to the detection of the expiration of a time window.

29. The system of claim 25 comprising a profile data store for the storage of a user profile that identifies the content item and the extraction template.

30. The system of claim 25 wherein the template data store is operative to maintain a storage template comprising one or more storage rules for storage of the video stream.
